(19) United States
(12) Patent Application Publication
(10) Pub. No.: US 2016/0025577 A1
(43) Pub. Date: Jan. 28, 2016

(54) Differential temperature surface sensor

(71) Applicants: CENTRE NATIONAL DE LA RECHERCHE SCIENTIFIQUE (C.N.R.S.), Paris (FR); ECOLE NATIONALE SUPERIEURE DE MECANIQUE ET DES MICROTECHNIQUES, Besançon (FR)

(72) Inventors: Bruno FRANCOIS, Besancon (FR); Sylvain BALLANDRAS, Besancon (FR); Denny RICHTER, Munich (DE)

(73) Assignees: CENTRE NATIONAL DE LA RECHERCHE SCIENTIFIQUE (C.N.R.S.), Paris (FR); ECOLE NATIONALE SUPERIEURE DE MECANIQUE ET DES MICROTECHNIQUES, Besançon (FR)

(21) Appl. No.: 14/811,307

(22) Filed: Jul. 28, 2015

(30) Foreign Application Priority Data
Jul. 28, 2014 (EP) 14306210.7

(51) Int. Cl. G01K 11/26

(52) U.S. Cl. CPC G01K 11/265

(57) ABSTRACT

This sensor, comprises: a first surface acoustic wave device, comprising a first piezoelectric substrate, formed from a (YXw/t)/φ/θ/ψ cut of a Langasite crystal, where φ is equal to 0±5° is equal to 55±20° and ψ is equal to 32.5±7.5° and a first resonator having a first transducer laying on a first propagation surface and having two sets of interdigitated first electrodes formed from an electrically conductive material having a high melting temperature; and a second surface acoustic wave device, comprising a second piezoelectric substrate, formed from a (YXw/t)/φ/θ/ψ cut of a Langasite crystal, where φ is equal to 0±5°, θ is equal to 5±20° and ψ is equal to 0±7.5°, and a second resonator having a second transducer laying on a second propagation surface and having two sets of interdigitated second electrodes formed from an electrically conductive material having a high melting temperature; said first and second surface acoustic wave devices being independent one from the other in terms of surface acoustic wave propagation.

The invention relates to surface acoustic wave sensors, or SAW sensors.

The measurement of a physical quantity at high temperature (above 300° C.) requires special materials and principles to withstand the corresponding environmental conditions.

As such, SAW sensors are good candidates, due to the existence of piezoelectric materials capable to operate at a very high temperature (around 1000° C.). Quartz, Langasite Gallium Orthophosphate, Aluminum Nitride, Zinc Oxide are examples of such piezoelectric materials.

In addition, SAW sensors can be remotely interrogated, providing a wireless measurement of a physical quantity.

Whatever this physical quantity is, it is better to put in place differential measurement to guarantee the measure of an absolute physical quantity o suppress correlated external perturbations affecting the sensor.

It is known from document WO2005/071375, a differential temperature SAW sensor comprising two SAW resonators on a same substrate made of Quartz.

These two resonators work with the same type of surface acoustic waves, namely Rayleigh waves, but have each a specific dependency of the resonance frequency with the temperature.

More specifically, each resonator is characterized by a specific turnover temperature Tt, which corresponds to the maximum of the parabolic function relating the resonance frequency with the temperature.

Because the turnover temperature Tt of uartz depends on the relative orientation between the alignment direction of the electrodes of the resonator and the propagation direction of the surface acoustic waves on the substrate, a SAW sensor exhibiting a required differential temperature sensitivity can be obtained through a careful choice of the relative orientation of each resonator.

Thus, Quartz appears to be very specific in that two different Rayleigh wave resonators can be made on the same AT cut (i.e, the single rotation cut, designated (YXl)/36° in the IEEE standard),

This is not the case for Langasite, where the propagation of Rayleigh waves in a single rotation cut does not allow for an easy and effective adjustment of the response of each resonator by a mere selection of their relative orientation on the same substrate.

More generally, except for pure shear waves (i.e. Bleustein-Gulyaev waves), there no Langasite cuts allowing an easy and efficient adjustment of the temperature coefficients of frequency (TCF) by a mere selection of the relative orientation of the resonators on the substrate.

The aim of the invention is to answer this problem, by providing a method for the design of a differential temperature SAW sensor made with Langasite. An object of the invention is a differential temperature SAW sensor according to the appended claims.

Preferred embodiments, of the invention will now be described, by way of example only, with reference to the accompanying drawings, of which:

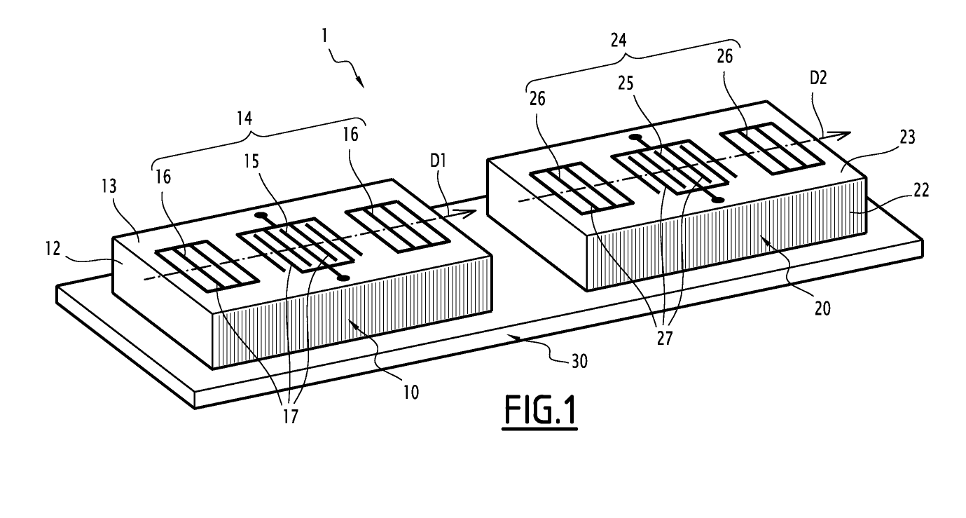

FIG. 1 is a schematic view of the structure of a preferred embodiment of a differential temperature SAW sensor;

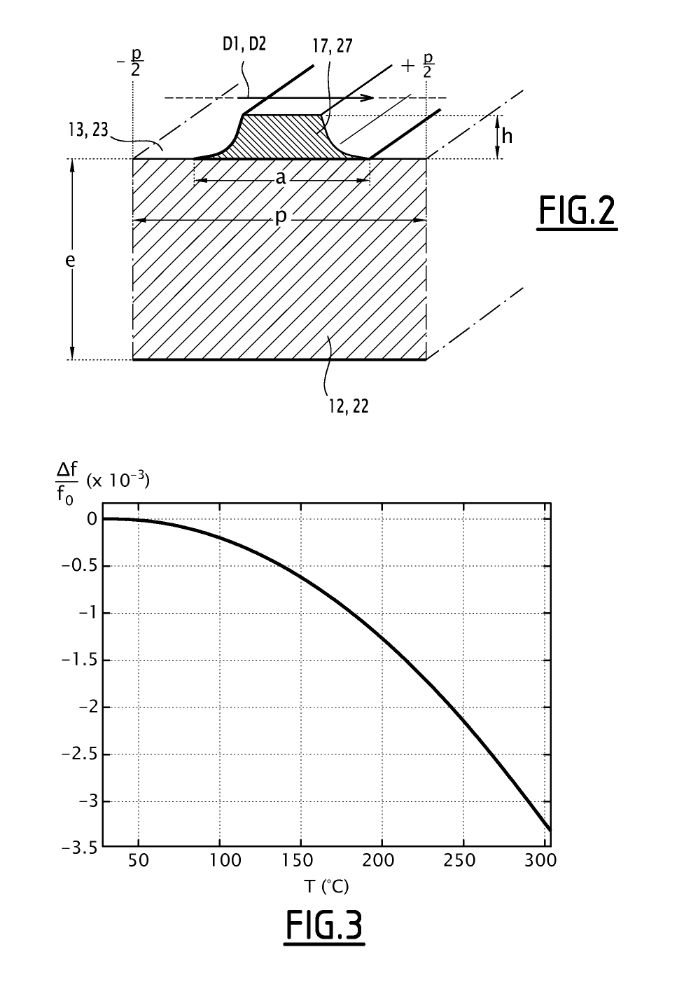

FIG. 2 shows a section of the structure of the sensor of FIG. 1, zoomed around an electrode of one of the resonators;

FIGS. 3 shows experimental results for TCF on a (YX/t)/48.5°/26.7° cut of Langasite for Rayleigh waves (electrodes made of Iridium);

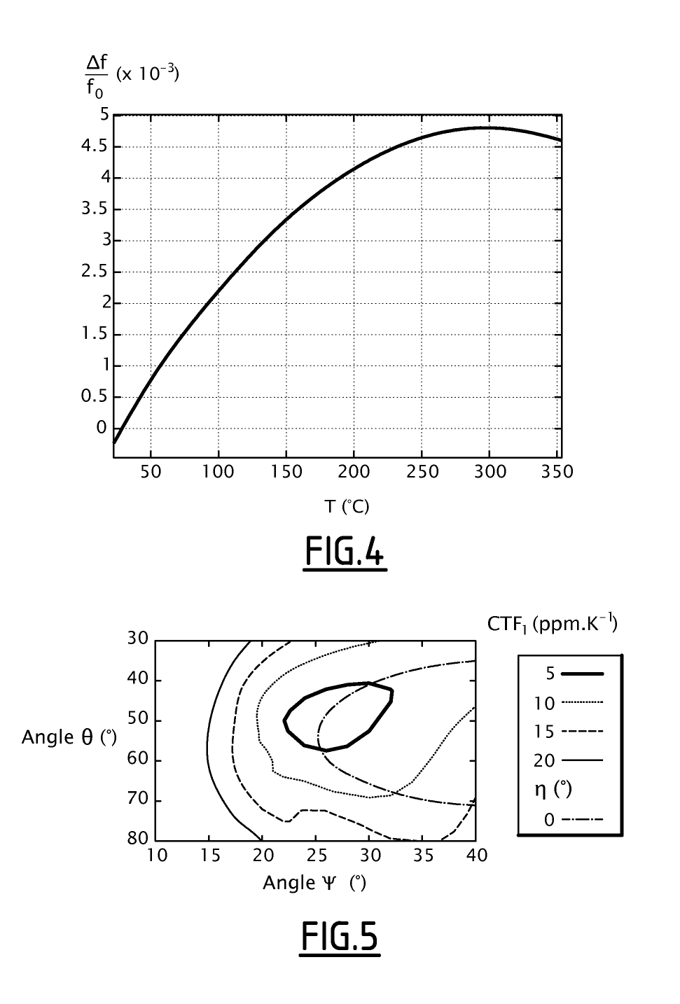

FIGS. 4 shows experimental results for TCF on a (YX) cut of Langasite for Rayleigh waves (electrodes made of Iridium);

FIGS. 5 shows, for a (YX/t)/θ/ψ cut (according to the definition of IEEE Std-176), different values of CTF₁ as a function of cut angle θ and ψ in the vicinity of θ=48.5° and ψ=26.7°, with a curve corresponding to a zero value for the energy flux η (also called power flow) angle;

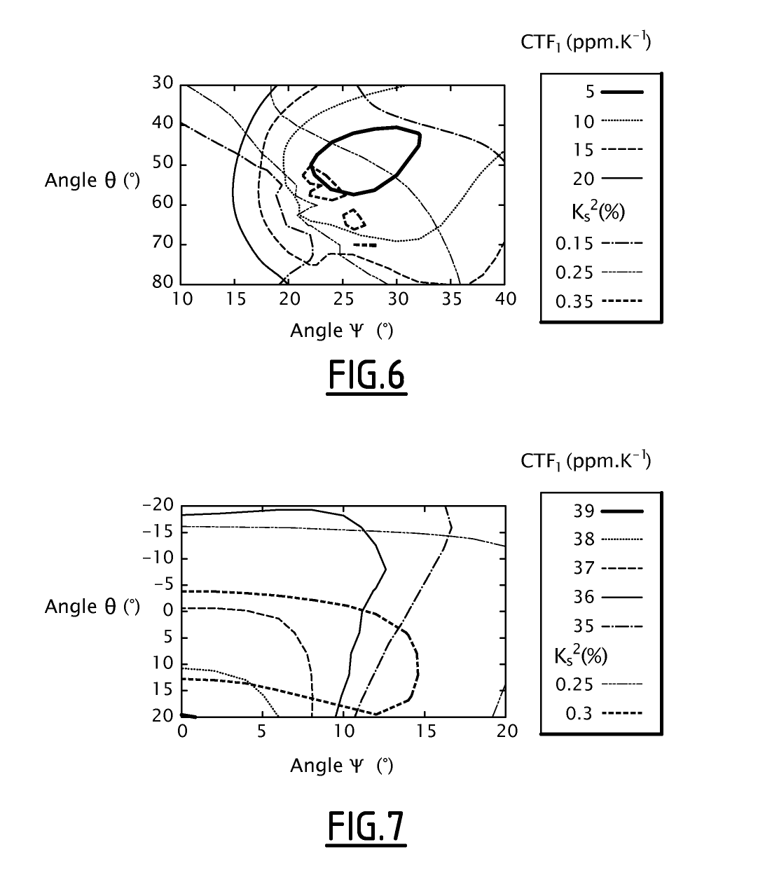

FIGS. 6 shows, for a (YX/t)/ θ/ψ cut, different values of CTF₁ as a function of θ and θ in the vicinity of θ=48.5 and ψ=26.7°, with several curves corresponding to different values for the electromechanical coupling:

FIGS. 7 shows, for a (YX) θ/ψ cut (according to the definition of IEEE Std-176), different values of CTF₁ as a function of θ and if in the vicinity of θ=0.° and ψ=0.° (the so-called (YX) cut), with several curves corresponding to different values for the electromechanical coupling;

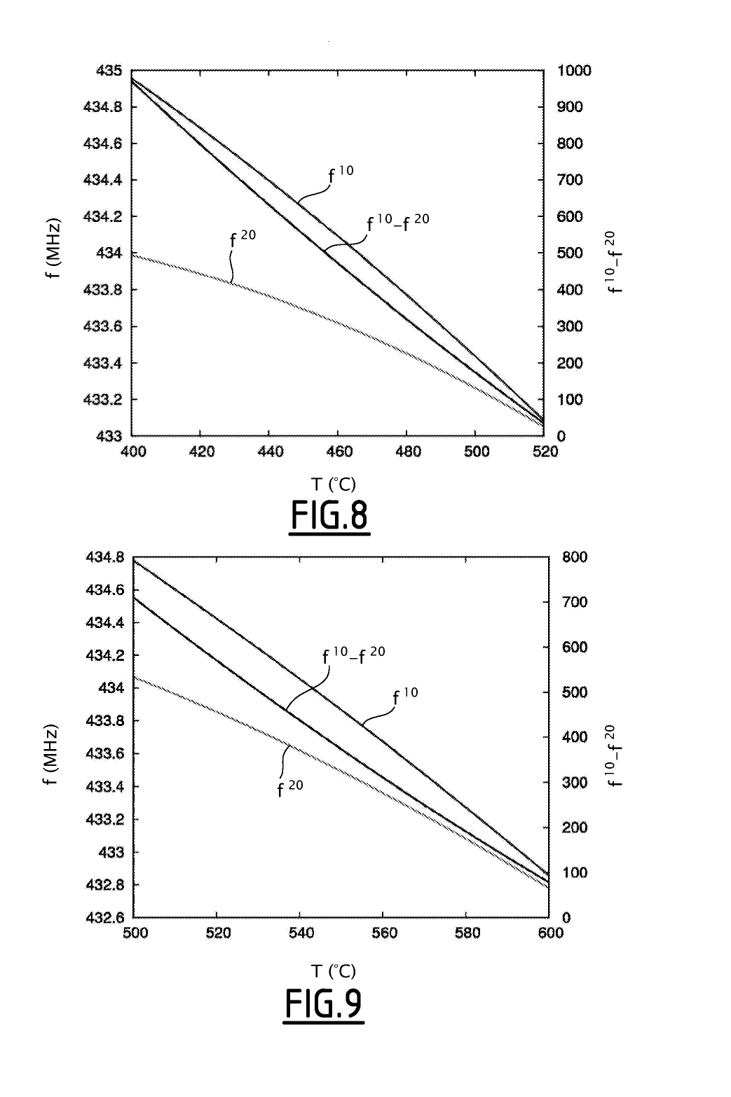

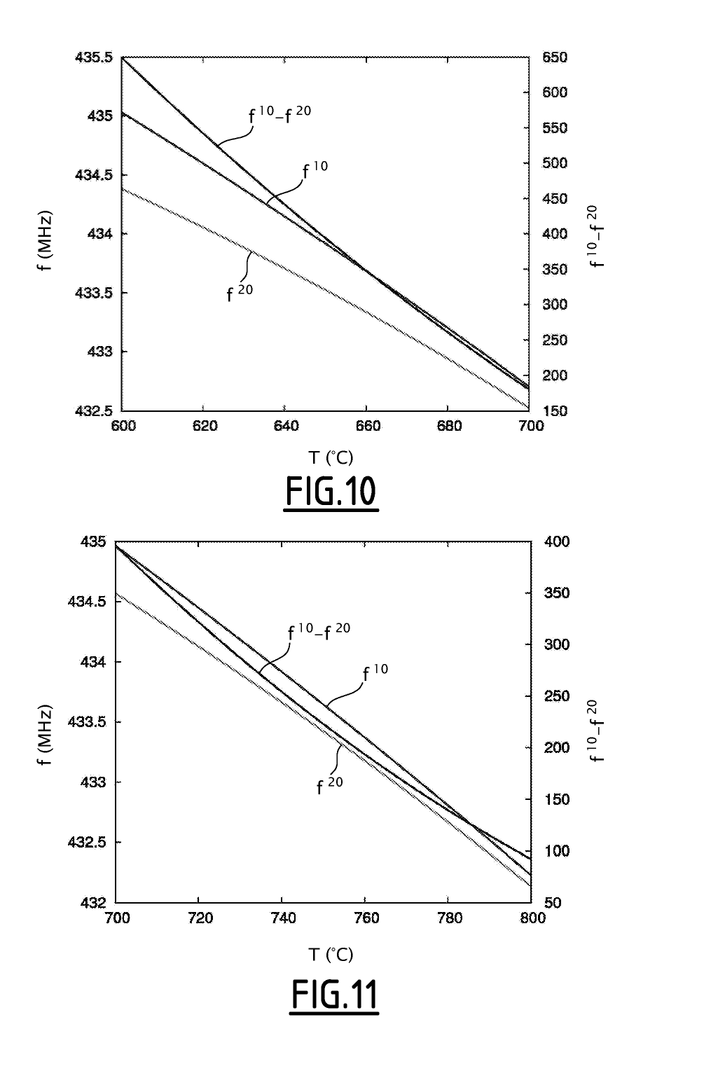

FIGS. 8 to 11 correspond to a frequency-temperature map for the first and second resonators of the sensor of FIG. 1, respectively between 400 and 520° C., 500 and 600° C., 600 and 680° C., and 700 and 770° C.;

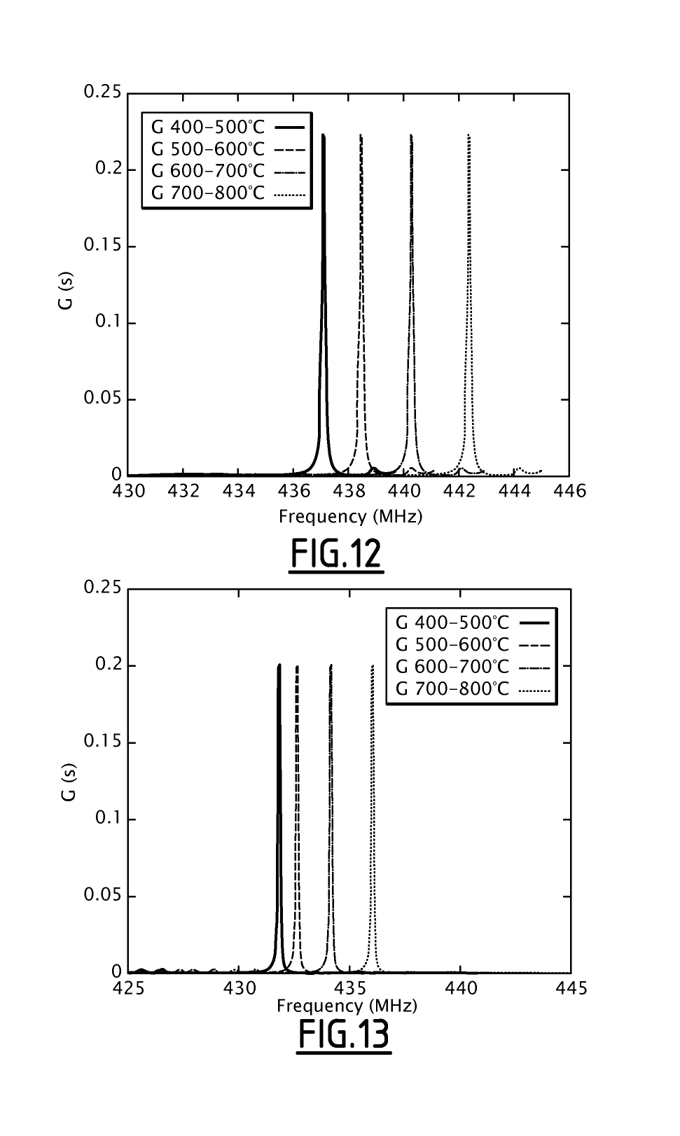

FIG. 12 shows the conductance at room temperature of the Ti/Pt-electrode-based transducer of the first resonator on a (YX/t)/48.5°/26.7° Langasite cut, for the four considered temperature intervals of the maps of FIGS. 8 to 11:

FIG. 13 shows the conductance at room temperature of the Ti/Pt-electrode-based transducer of the second resonator on a (YX) Langasite cut for the four considered temperature intervals;

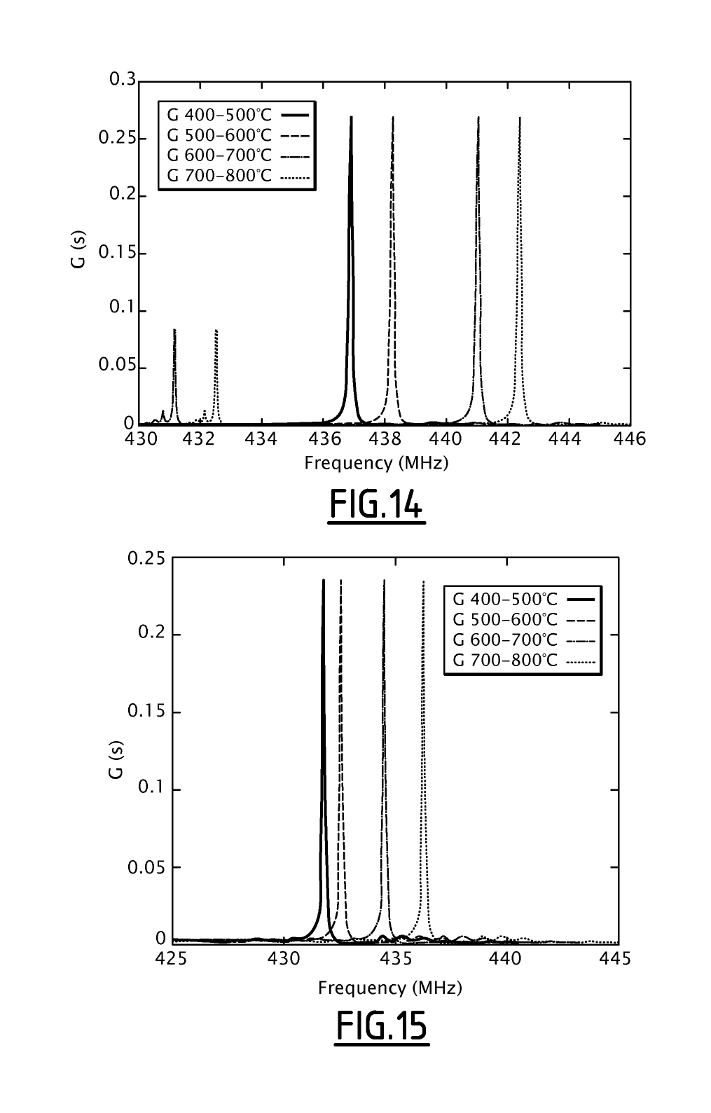

FIG. 14 shows the conductance at room temperature of the Ni-electrode-based transducer of the first resonator on a (YX/t)/48.5°/26.7° Langasite cut for the four considered temperature intervals;

FIG. 15 shows the conductance at room temperature of the Ni-electrode-based transducer of the second resonator on a (YX) langasite cut for the four considered temperature intervals;

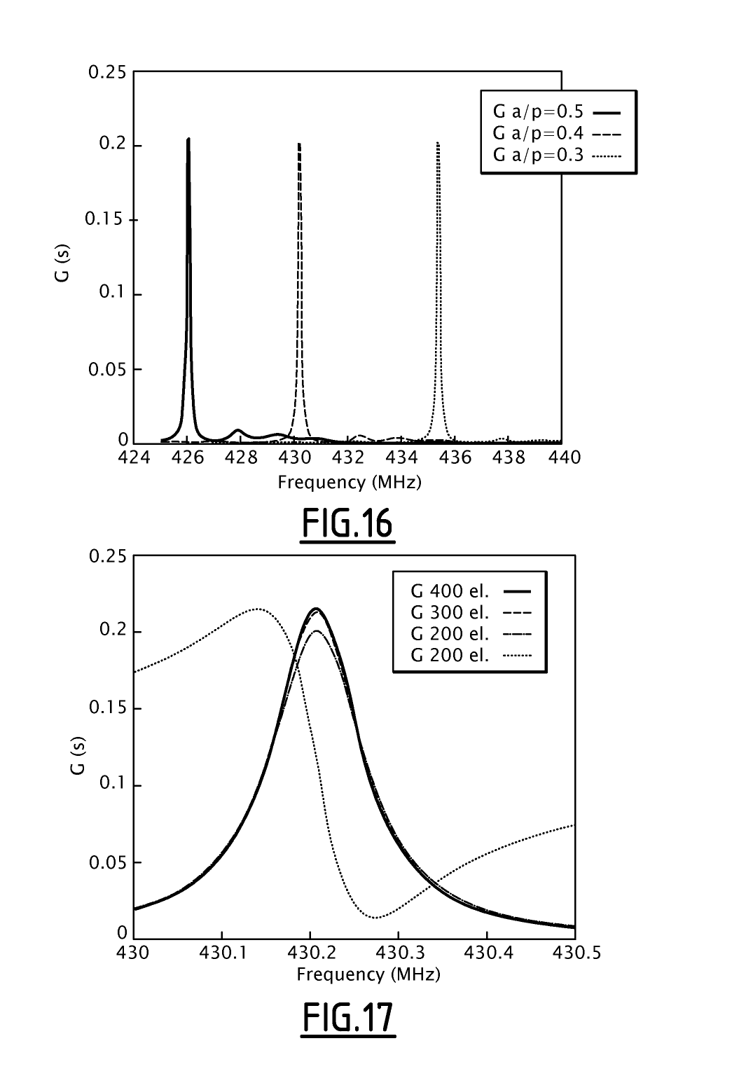

FIG. 16 shows the influence of the metallization ratio on the conductance for the design of the first SAW device on the (YX/t)/48.5°/26.7° Langasite cut; and,

FIG. 17 shows the influence of the number of electrodes on the conductance in the first mirrors for the design of the first resonator on the (YX/t)/48.5°/26.7° Langasite cut

The preferred embodiment of a differential temperature SAW sensor 1 is shown on FIGS. 1 and 2. This sensor comprises a first SAW device 10 and a second SAW device 20 supported mechanically on a common plate 30.

The first SAW device 10 comprises a first piezoelectric substrate 12, which is obtained from a crystal of Langasite, cut along a first cut.

The first SAW device 10 comprises a first resonator 14, which is fixed on a surface of the substrate 12. The surface acoustic waves will propagate on said surface of the substrate 12. This surface is called the first propagation surface and is referenced by number 13 in FIG. 1. The first resonator 14 comprises a first transducer 15 extending along a irat main direction D1.

Along direction D1, the first transducer 15 is located between two identical first mirrors 16.

The first transducer 15 and the first mirrors 16 are each made of two sets of first electrodes 17, aligned along the first direction D1. As known, the two sets form an interdigitated pattern.

The first electrodes 17 are formed from an electrically conductive material having a high melting temperature. This material is selected in the group comprising Ta/Pt, Cr/Au, Cr/Ni, Mo, W, Cr/Cu/Cr, Cr, Pb, Ir, Zr and the alloy thereof.

The second SAW device 20 comprises a second piezoelectric substrate 22, which is obtained from a crystal of Langasite, cut along a second cut.

The second device 20 comprises a second resonator 24, fixed on a surface of the second substrate, on which the surface acoustic waves will propagate. This surface is called the second propagation surface 23.

The second resonator 24 comprises a second transducer 25 extending along a second main direction D2.

Along direction D2, the second transducer 24 is placed between two identical second mirrors 26.

The second transducer 25 and the second mirrors 26 are made of two sets of second electrodes 27, aligned along the second direction D2. As known, the two sets form an interdigitated pattern.

The second electrodes 27 are formed from an electrically conductive material having a high melting temperature. This material is selected in the group comprising Ta/Pt, Cr/Au, CriNi, Mo, W, Cr/Cu/Cr, Cr, Pb, Ir, Zr and their alloy. Preferably the material of the first and second electrodes is identical to make easier the method of realization of such a sensor.

The first and second devices are independent one from the other in terms of surface acoustic wave propagation.

As shown in FIG. 2, in a transducer, the width of an electrode 17, respectively 27, along the main direction D1, D2, is labeled a, the thickness of an electrode along a normal direction to the propagation surface 13, 23, is labeled h, the pitch between two successive electrodes is labeled p, and the thickness of the piezoelectric substrate 12, 22, is labeled e. The length of an electrode may vary along the pattern of the transducer, as it is well known for the skilled person.

### Selection of the Langasite Cuts

Rayleigh waves on single crystal piezoelectric Langasite substrates have a temperature sensitivity which depends of the crystallographic orientation,

This property leads to the possibility to design a differential temperature SAW sensor comprising two independent SAW devices selected on their relative TCF.

By an optimized selection of the Langasite cuts, it is possible to achieve a noticeable difference of thermal sensitivity between the two devices, which is suitable for high temperature applications.

The family of cuts identified by Naumenko et al. in patent application EP 1 022 852 are good candidates. However, this document is focused on the compensation of temperature effects in standard conditions of use (i.e. in the temperature range between −20° C. and and 80° C.) in filter having a relatively reduce width (less than 1%) in the frequency range of 50 to 300 MH_{z}. In addition, this family of cuts suffers the drawback of a sensitivity to the angle of the energy flux η. This problem is inherent to the choice of a surface wave propagation axis out of the crystal axis.

According to the invention, the two substrates are cut according to the two following ranges.

The cut of the first substrate 12 is a (YXw/t)/φ/θ/ψ cut of a Langasite crystal, with φ equal to 0±5°, θ equal to 55±20° and equal to 32.5±7.5°.

The cut of the second substrate 22 is a (YXw/t)/φ/θ/ψ cut of a Langasite crystal, with φ equal to 0±5°, θ equal to 5±20° and ψ equal to 0±7.5°.

These results come from the following method.

FIG. 3 shows the measurement of the dependency of the frequency relative variation

$$\frac{Δ f}{{f}_{0}}$$

over temperature T for a (YX/t)/48.5°/26.7° cut of Langasite (the omission of w in the previous notation means a zero value for φ).

FIG. 4 shows the measurement of the dependency of the frequency relative variation

$$\frac{Δ f}{{f}_{0}}$$

over temperature T for a (YX) cut of Langasite, which corresponds to a (YXw/t)/0°/0°/0° cut.

The curves of FIGS. 3 and 4 are each fitted with a quadratic function according to the following relation:

$$\frac{f - {f}_{0}}{{f}_{0}} = \frac{Δ f}{{f}_{0}} = {TCF}_{1} ( T - {T}_{0} ) + {{TCF}_{2} ( T - {T}_{0} )}^{2} \qquad ( 1 )$$

Where:

T is the measured temperature;

Tₒ is a reference temperature, equal for example to 25° C.;

TCF₁ is a first order coefficient of the TCF;

TCF₂ is a second order coefficient of the TCF;

f is the resonance frequency of the sensor at temperature T;

fₒ is the resonance frequency of the sensor at temperature T₀; and,

Δf is the difference between f and f₀

For the (YX/t)/48.5°/26.7° cut, TCF₁¹⁰ and TCF₂¹⁰ are equal to +3.5 ppm.K⁻¹ and −45 ppm.K⁻² respectively.

For the (YX) cut, TCF₁²⁰ and TCF₂²⁰ are equal to +38.5 ppm.K⁻¹ and −65 ppm.K⁻² respectively.

It is to be noted that the TCF coefficients can hardly be modified by a rotation of the orientation of the main direction of the transducer relative to the propagation direction of the acoustic waves on the propagation surface without degrading the other characteristics of the wave (coupling coefficient, beam-steering angle, directivity).

These measurements of the TCF coefficients avow the calibration of a physical model describing the behavior of the first substrate in one hand and the second substrate in the other hand. The physical model used is defined in the article by I. Silvestrova, P. A. Senushenkov, V. Bezdelkin and Yu. V. Pisarevsky: Proc. IEEE Freq. Contr. Symp. (1993) p. 348 , the article by I. M. Silvestorva, Yu. V. Pisarevsky, P. A. Senyushchenkov and A. I. Krupny: Soy. Phys. Solid State 28 (1986) 1613, and the article by A. A. Kaminskii, 1. M. Silvestrova, S. E. Sarkisov and C. A. Denisenko: Phys, Status Solidi (a) V80 (1983) 607.

With this physical model, correctly calibrated, curves of FIGS. 5 to 7 are calculated representing curves of isovalue for the CTF₁ coefficient over both angle θ and angle Ψ.

In FIG. 5 is also represented the isovalue curve energy flux angle η equal to zero. In FIG. 6 are also represented the isovalue curves for the electromechanical coupling Kₛ².

FIGS. 5 and 6 allow the identification of the best range for the cut of the substrate 12 of the first SAW device 10, “Best range” means the ranges both in θ and Ψ that maximize the CTF₁ coefficient.

In FIG. 7 are also represented the isovalue curves for the electromechanical coupling Kₛ².

FIG. 7 allows the identification of the best range for the cut of the substrate 22 of the second SAW device 20. For this latter cut, only the electromechanical coupling is taking into account, because in the neighborhood of the (YX) cut, the energy flux angle η is always zero, for a propagation along axis X, and CTF1 is nearly constant, what offers few degrees of liberty for optimizing the second cut.

The two ranges defined above are thus obtained.

### Selection of the Resonance Frequency of the First and Second Devices

This step is dedicated to the optimization both of the temperature sensibility and the temperature range of the SAW sensor 1.

The range of frequencies on which the SAW sensor is intended to operate is defined.

In the present embodiment, sensor 1 is designed to operate in the so-called “Industrial Science Medical” band (ISM). Although some applications may not require such specification, this constraint makes sense as it limits the impact on the electronics (i.e. the reader should not be customized for each temperature range). One of the most used ISM band in the European Community is centered on 434 MHz and has a width of 1.7 MHz. Other ISM bands may be exploited such as the one at 866 MHz with a quite small frequency band width (˜0.85 MHz) or the one used in the United States of America, centered in 915 MHz with a bard width of about 27 MHz. The ISM band centered in 2.45 GHz imposes technology specification hardly compatible with the use of Rayleigh waves on Langasite. Typically, for each first and second devices, a measurement in a temperature range having a width of 100° C. and in an ISM frequency band corresponds to a maximum TCF difference of 39 ppm.K.₁. Therefore the range of temperature on which the SAW sensor is intended to operate is defined.

A frequency f versus temperature T map is established for a plurality of temperature intervals. For example, four temperature intervals are considered in FIGS. 8 to 11. A first curve gives the dependency of the resonance frequency f₁₀ of the first resonator 10 over the temperature T, a second curve gives the dependency of the resonance frequency f₂₀ of the second resonator 20 over the temperature T, and the third curve gives the dependency of the difference between the resonance frequency f₁₀ of the first resonator 10 and the resonance frequency f₂₀ of the second resonator 20 over the temperature T.

On a given temperature interval, the first resonance frequency f₁₀ of the first device 10 is fixed near 435 MHz at the lower edge Tₘᵢₙ of the temperature intervals.

Then, the second resonance frequency f²⁰ of the second device 20 is defined to be certain to have f¹⁰-f²⁰>0 on the whole temperature interval. Because f¹⁰ decreases with T to reach the value of approximately 433.2 MHz at the upper edge Tₘₐₓ of the temperature interval, the resonance frequency f²⁰ is set at 433.1 MHz at the upper edge of the temperature interval. From these settings and the measured values of the TCF coefficients indicated above, f₀¹⁰ and f₀²⁰ can be calculated on each point of the temperature interval.

The resonance frequencies of the four SAW sensor configurations of the four maps of FIGS. 8 to 11 are reported in Table 1.

TABLE 1

| Temperature sub-range (° C.) | 400-500 | 500-600 | 600-700 | 700-800 |
|---|---|---|---|---|
| device 10 | 437.15 | 438.5 | 440.7 | 443 |
| fₒ¹⁰ (MHz) at T₀ = 25° C. | | | | |
| device 20 | 431.7 | 432.5 | 434.1 | 436.15 |
| fₒ²⁰ (MHz) at T₀ = 25° C. | | | | |
| f¹⁰-f²⁰ excursion | ~800 | 650 | 470 | 300 |
| on the whole temperature range | | | | |
| (kHz) | | | | |
| Linearized sensitivity (kHz · K⁻¹) | 8 | 6.5 | 4.7 | 3.0 |

These results are shown in FIGS. 12 and 13 and FIGS. 14 and 15 for two types of electrodes. These figures represent the variation of the conductance 6 of the resonator 1 with the frequency for each of the four ranges of temperature. For FIGS. 12 and 13, the electrodes are made of Platinum bond to the acoustic surface of the substrate through a layer of titanium. For FIGS. 14 and 15, the electrodes are made of Nickel bond directly on the acoustic surface of the substrate.

Incidentally, because the spectral distance f¹⁰-f²⁰ decreases with T, the sensor sensitivity is decreasing along the temperature range.

The first configuration is theoretically capable to operate up to 520° C., whereas the fourth is limited to 770° C. (still considering the ISM band constraint).

The full temperature range has been limited to an upper temperature of 800° C., as the selected cuts hardly allow for sensing above this temperature (in the 800-900° C. the differential sensitivity falls down to 1 kHz.K⁻¹).

These frequencies have been set considering Q factors that are large enough to allow for the detection of two resonances without overlapping problems. However, at room temperature, the actual Q factor of the resonators should not exceed 6000, even with optimized electrodes. It may thus reduce to a value between 1000 and 2000 at working temperature. This means that the simulation illustrated in the figures may prove to be optimistic and therefore the full temperature range for which the sensor allows for actual measurement may be reduced (particularly for temperatures above 700° C.).

A solution for such issue consists in enlarging the spectral distance f¹⁰-f²⁰ between the two resonators, at the price of missing the respect of ISM regulations. Although not considered in the present design method, this feature can be easily achieved by sorting resonators from one design another and assorting devices to form the differential sensor (for instance coupling one (YX) cut resonator operating in the 600-680° C. range with one (YX/t)/148.5°/26.7° cut resonator operating in the 700-770° C. range).

### Adjustment of the Structure of the Resonators

The general configuration of the SAW sensor having been determined, the next step is dedicated to a precise adjustment of the structure of each resonator, in order they effectively operate according to the resonance frequencies defined in Table 1.

Here, it is necessary to optimize both of the temperature sensibility and the temperature range of the propagation mode used (here the Rayleigh mode), taking into account the structure of the resonator and its impact on the acoustic waves in order to design a balanced sensor in terms of the two resonance frequencies of its spectral response.

To this end, a computer program is used in order to estimate the physical parameters of the resonators. This program is based on a model of a resonator, allowing the determination of the influence of these parameters on the Rayleigh wave propagation.

Simulations for each of the four SAW sensor configurations of Table 1 are computed. Several Figures such as FIGS. 16 and 17 are obtained. In these figures the conductance G of the resonator is shown with respect of the frequency for each range of temperature.

For each configuration, the best values for the parameters of the first resonator 14, provided with Ti/Pt electrodes, made of a layer of 10 nm thickness of Ti and a layer of 150 nm thickness of Pt, and a 280 μm width are given in Table 2:

TABLE 2

| | 400- | 500- | 600- | 700- |
|---|---|---|---|---|
| Electrode parameters | 500° C. | 600° C. | 700° C. | 800° C. |
| p (μm) | 2.95 | 2.94 | 2.925 | 2.91 |
| a/p (μm) | 0.4 | 0.4 | 0.4 | 0.4 |
| Number of electrodes | 200 | 200 | 200 | 200 |
| in the transducer | | | | |
| p mirror (μm) | 2.97 | 2.96 | 2.945 | 2.93 |
| a/p mirror (μm) | 0.4 | 0.4 | 0.4 | 0.4 |
| Number of electrodes | 300 | 300 | 300 | 300 |
| in each mirror | | | | |

The choice of a metallization ratio alp equal to 0.4 actually corresponds to the best trade-off for Q factor and electromechanical coupling optimization considering the above Ti/Pt metallization. For example, a/p=0.5 corresponds to Q=2898 and ks=²3.1, a/p=0.4 Q=3282 and ks²=3.3, and a/p=0.3 to Q=3452 and ks²=2.9.

It turns out that 300 electrodes in the mirror are sufficient to reach the same Q factor as obtained experimentally with 400 electrodes. The number of electrodes of the mirror is thus reduced, yielding smaller resonator dimensions (less than 2.5 mm long for the configurations of Table 2), The trade-off is fixed to 300 electrodes as it clearly meets the asymptotic limit assuming equivalent loss of 5×10⁻³ dB/A. Assuming an equivalent loss coefficient of 5×10⁻³ dB/λyields to a theoretical 0 factor in excess of 3500, and the predicted coupling coefficient is larger than 0.3%.

Similarly, the best values for the parameters of the second resonator 24, provided with Ti/Pt electrodes of 10 nm and 150 nm thickness respectively and a 280 μm aperture, are given in Table 3.

TABLE 3

| | 400- | 500- | 600- | 700- |
|---|---|---|---|---|
| Electrode parameters | 500° C. | 600° C. | 700° C. | 800° C. |
| p (μm) | 2.585 | 2.58 | 2.57 | 2.58 |
| a/p (μm) | 0.6 | 0.6 | 0.6 | 0.6 |
| Number of electrodes | 200 | 200 | 200 | 200 |
| p mirror (μm) | 2.585 | 2.58 | 2.57 | 2.558 |
| a/p mirror (μm) | 0.55 | 0.55 | 0.55 | 0.55 |
| Number of electrodes | 200 | 200 | 200 | 200 |
| in each mirror | | | | |

The optimization of the second resonator is much easier to achieve because it does not exhibit any directivity property. To get rid of these directivity effects, the man of the art will refer to patent EP 2 156 554 B1 by Pennavaire, Pastureaud and Ballandras. The resonance occurs at the upper edge of the frequency stop-band of the mirror, considering a mirror whose electrodes are 150 nm thick of Pt. Therefore, a particular attention must be paid to optimize the second resonator. As the stop-band of the mirror must recover the synchronism condition of the interdigitated transducer, it must be slightly shifted toward frequencies slightly higher than the resonance condition. This can be easily achieved by reducing the metallization ratio of the mirror electrodes. The reflection coefficient is much larger for the (YX) cut than for the (YX/t)/48.5°/26.7° cut. This means that the mirror grating can significantly be shorted compared to the structure of the first resonator. Moreover, as the phase velocity also is smaller on (YX) cut than on the (YX/t)/48.5°/26.7° cut, the structure of the second resonator is expected to exhibit a significantly smaller overall length than the first resonator.

Further, the Q factor of the second resonator is slightly larger than what obtained for the first resonator (4800 compared to 3500) but the electromechanical coupling Ks is smaller (0.26%). Although this means that both resonators will not meet absolutely the same electrical characteristics, nor the Q factor of the second resonator neither the electromechanical coupling of the first resonator are modified, because both these parameters play a role in the wireless interrogation of the sensor, and the designed structures actually corresponds to the best trade-off.

The same calculation has been performed considering Ni electrodes, in that configuration, electrode thickness of 200 nm, and width of 300 pm have been considered.

The results for the first resonator are shown in Table 4.

TABLE 4

| | 400- | 500- | 600- | 700- |
|---|---|---|---|---|
| Electrode parameters | 500° C. | 600° C. | 700° C. | 800° C. |
| p (μm) | 3.06 | 3.07 | 3.09 | 3.10 |
| a/p (μm) | 0.6 | 0.6 | 0.6 | 0.6 |
| Number of electrodes | 200 | 200 | 200 | 200 |
| p mirror (μm) | 3.06 | 3.07 | 3.09 | 3.10 |
| a/p mirror (μm) | 0.7 | 0.7 | 0.7 | 0.7 |
| Number of electrodes | 200 | 200 | 200 | 200 |
| in each mirror | | | | |

Parasites appear at low frequencies for the design on (YX/t)/48.5°/26.7° cut but they theoretically should remain out of the ISM band once achieving the nominal temperature.

The resonance mainly occurs at the end of the stop band, which is on line with the reported prediction, showing the quite large natural directivity properties of this configuration.

The results for the second resonator, with 200 nm thickness and 400 pm aperture Ni electrodes are shown in table 5 below.

TABLE 5

| | 400- | 500- | 600- | 700- |
|---|---|---|---|---|
| Electrode parameters | 500° C. | 600° C. | 700° C. | 800° C. |
| p (μm) | 2.642 | 2.637 | 2.625 | 2.614 |
| a/p (μm) | 0.7 | 0.7 | 0.7 | 0.7 |
| Number of electrodes | 250 | 250 | 250 | 250 |
| p mirror (μm) | 2.652 | 2.647 | 2.635 | 2.624 |
| a/p mirror (μm) | 0.7 | 0.7 | 0.7 | 0.7 |
| Number of electrodes | 300 | 300 | 300 | 300 |
| in each mirror | | | | |

The second resonator appears a bit longer here as the reflection efficiency on (YX) cut is less than on (YX/t)/48°/26.7° cut. Also the aperture and the number of electrodes must be increased to meet similar conductance as obtained on the standard Rayleigh wave cut.

1. Differential temperature surface sensor comprising:
a first surface acoustic wave device, comprising:
a first piezoelectric substrate, formed from a (YX/t)/φ/θ/ψ cut of a Langasite crystal, where φ is equal to 0±5°, θ is equal to 55±20° and is equal to 32.5+7.5°, said first piezoelectric substrate having a first propagation surface;
a first resonator having a first transducer laying on said first propagation surface and having two sets of interdigitated first electrodes formed from an electrically conductive material having a high melting temperature;
a second surface acoustic wave device, comprising:
a second piezoelectric substrate, formed from a (YXw/t)/φ/θ/ψ cut of a Langasite crystal, where φ is equal to 0±5°, θ is equal to 5±20° and ψ is equal to 0±7.5°, said second piezoelectric substrate having a second propagation surface;
a second resonator having a second transducer laying on said second propagation surface and having two sets of interdigitated second electrodes formed from an electrically conductive material having a high melting temperature; said first and second surface acoustic wave devices being independent one from the other in terms of surface acoustic wave propagation.

2. Sensor according to claim 1, whose first surface acoustic wave device is characterize by a temperature coefficient of frequency with a first order coefficient (CTF₁) between 0 and 15 ppm.K⁻¹ and whose second surface acoustic wave device is characterize by a temperature coefficient of frequency with a first order coefficient (TCF₁) coefficient between 35 and 40 ppm.K⁻1.

3. Sensor according to claim 1, capable of operating at a temperature between 200 and 1000° C., preferably between 400 and 800° C., more preferably between 500 to 700° C.

4. Sensor according to claim 1, capable of operating on a temperature range having a width between 50 and 150° C., preferably equal to 100° C.

5. Sensor according to claim 1, wherein the first surface acoustic wave device operates at a first resonance frequency and the second surface acoustic wave device operates at a second resonance frequency, the first and second resonance frequencies being preferably in an ISM frequency band.

6. Sensor according to claim 5, wherein the difference between the first resonance frequency and the second resonance frequency is positive on the whole of a temperature range of operation of the sensor.

7. Sensor according to claim 1, wherein said first electrodes are made of Ti/Pt and the structure of the first transducer is given by a pitch equal to 2.9 μm, a metallization ratio of 0.4, and a number of first electrodes ranging for 50 to 200.

8. Sensor according to claim 7, wherein the first transducer is placed between a pair of first identical mirrors, each first mirror having around 300 electrodes, and substantially the same pitch and metallization ratio than the first transducer.

9. Sensor according to claim 7, wherein said second electrodes are made of Ti/Pt and the structure of the second transducer is given by a pitch equal to 2.5 μm, a metallization ratio of 0.6, and a number of first electrodes ranging from 50 to 200.

10. Sensor according to claim 9, wherein the second transducer is placed between a pair of second identical mirrors, each second mirror having around 200 electrodes, and substantially the same pitch than the second transducer but a metallization ratio of 0.55.

11. Sensor according to claim 1, wherein said first electrodes are made of Ni and the structure of the first transducer is given by a pitch equal to 3.0 μm, a metallization ratio of 0.6, and a number of first electrodes ranging from 50 to 200.

12. Sensor according to claim 11, wherein the first transducer is placed between a pair of first identical mirrors, each first mirror having around 200 electrodes, with the same pitch than the first transducer but a metallization ratio equal to 0.7.

13. Sensor according to claim 11, wherein said second electrodes are made of Ni and the structure of the second transducer is given by a pitch equal to 2.6 μm, a metallization ratio of 0.7, and a number of first electrodes ranging from 50 to 250.

14. Sensor according to claim 13, wherein the second transducer is placed between a pair of second mirrors, each second mirror having around 300 electrodes, with the same pitch and metallization ratio than the second transducer.

14. Sensor according to claim 1, wherein the material of the first and second electrodes is selected in the group comprising Ta/Pt, Ti/Pt, Cr/Au, CriNi, Mo, W, Cr/Cu/Cr, Cr, Ni. Pb, Ir, Zr, Ni and the alloy thereof.
